(19) United States
(12) Patent Application Publication
(10) Pub. No.: US 2010/0020168 A1
(43) Pub. Date: Jan. 28, 2010

(54) METHOD AND EQUIPMENT FOR MEASUREMENT OF INTACT PULP FIBERS

(76) Inventor: Chun Ye, Kajaani (FI)

Correspondence Address: FASTH LAW OFFICES (ROLF FASTH), 26 PINECREST PLAZA, SUITE 2, SOUTHERN PINES, NC, 28387-4301, US

(21) Appl. No.: 12/376,020

(22) PCT Filed: Jul. 24, 2007
(86) PCT No.: PCT/FI2007/000193

§ 371 Date: Jul. 20, 2009

(30) Foreign Application Priority Data
Aug. 3, 2006 (FI) 20060715

(51) Int. Cl. G06T 7/00; G01N 21/84; G01N 21/25; H04N 7/18

(52) U.S. Cl. 348/92; 356/303; 382/141; 348/E07.085

(57) ABSTRACT

A non-destructive method capable of real-time or on-line measurement of a wood or pulp fiber without sample pretreatment for the microfibril angle and the path difference. A circular polariscope in combination with a line spectral camera generating a micrograph insensitive to the orientation of a fiber and determined only by the fiber's properties related to polarized light. A line image across the fiber is captured and dispersed it into a spectral image to perform a real-time spectral analysis of the fiber's image.

### FIELD OF THE INVENTION

This invention relates to a method and equipment for real-time or on-line measurement of intact wood or pulp fibers, more particularly for measurement of a fiber for the microfibril angle and the path difference, a parameter proportional to the cell wall thickness. The method and equipment can be modified for real-time or on-line measurement of other birefringent samples, including retardation films and waveplates.

### BACKGROUND OF THE INVENTION

Wood or pulp fibers are closely related to paper properties. The increasing demand on high quality paper products requires optimal and more efficient use of the available wood fiber resources. Fibers' properties vary widely and they are different from fiber to fiber even within a tree. Research and analytical tools for measuring the properties of single pulp fibers are essential for a better utilization of available wood resources. The basic characteristics of a fiber include the fiber's length, width, shape, microfibril angle (MFA) and cell wall thickness (CWT). On-line measurement equipment is commercially available only for the fiber length, width and shape. The MFA and CWT are difficult to measure due to the fiber's two-wall structure.

A wood fiber is made of a primary wall enveloped in lignin to form the middle lamella and a secondary wall comprising three secondary layers, called S₁, S₂ and S₃ layers (e.g. ref. Preston, R. D. (1974), The physical biology of plant cell walls, Chapman and Hall Ltd.). All the three secondary layers are concentric and composed of cellulosic microfibrils, embedded in an amorphous matrix of hemicelluloses and lignin. The outer secondary layer S₁ and the inner secondary layer S₃ are very thin, and their microfibrils are wound almost transversely to the fiber axis. The middle layer S₂ contains the majority of the cell-wall material (80-95%) (see Page, D. H. (1969), Journal of Microscopy 90, 137-143 and Prud'homme, R. E. and Noah, J. (1975), Wood and fiber 6, 282-289) and it is widely accepted that a wood or pulp fiber can be approximated with the S₂ layer. The microfibrils of the S₂ layer trace a steep spiral around the fiber axis with the microfibrils of the layer's front and back walls crossed. The angle between the fibrillar direction and the fiber axis is termed the microfibril angle or S₂ fibril angle of the fiber.

The experimental evidences provided by a number of investigations (e.g. see Mark, R. E. and Gillis, P. P (1973), Tappi 56, 164-167; El-Hosseiny, F. and Page, D. H. (1975), Fibre Science and Technology 8, 21-30; Page, D. H., El-Hosseiny, F., Winkler, K., and Lancaster, A. P. S. (1977), Tappi 60, 114-117; and Page, D. H. and El-Hosseiny, F. (1983), Journal Pulp and Paper Science, TR 99-100) indicate that the MFA φ is closely related to the mechanical properties of the fibers, such as the strength, the elastic modulus and the shrinkage. The CWT is a parameter often involved in pulp fiber measurement. For instance, the CWT is related to the fiber flexibility, strength and collapsibility (e.g. Dinwwodie, J. M. (1965), Tappi 48, 440-447; Horn, R. A. (1974), USDA For. Serv. Res. Pap. FPL 242, Horn, R. A. (1978), USDA For. Serv. Res. Pap. FPL 312 and Jang, H. F. and Seth, R. S. (1998), Conference proceeding. 84th annual meeting, Canadian Pulp and Paper Association, Montrel 27-30 Jan. 205-212) and it is also related to the surface quality and optical properties of paper.

To determine the MFA and/or the CWT, methods have been developed and used, for example the striation observation, angle of the slit pits, iodine staining, X-ray diffraction, confocal laser scanning microscopy (CLSM) and imaging ellipsometry. The first three techniques are tedious and only applicable to some wood species. The X-ray diffraction method generally is suitable for giving a measure of the mean microfibril angle of a piece of wood consisting of a few hundred fibers. Additionally, the application of the X-ray technique relies heavily on fiber geometry that is uncertain (see e.g. Prud'homme R. E. and Noah, J. (1975), Wood and fiber 6, 282-289).

The CLSM can be used for optically sectioning a wood or pulp fiber and generating its cross-sectional image. With the help of image analysis, the CLSM can determine fiber's transverse dimensions, including the CWT (e.g. Jang, H. F., Robertson, A. G. and Seth, R. S. (1992), Journal of Materials Science, 27, 6391-6400). To generate a cross-sectional image, a fiber is optically scanned in the cross-sectional direction while the fiber is stepped in the perpendicular direction and cross-sectional image is reconstructed from a series such line scans. A fiber for measurement by this technique needs to be pretreated, for example dyed with fluorochrome dye, and oriented to be perpendicular to the scanning direction. By combining the optical sectioning ability of the confocal microscope with the difluorescence of fluorochromadyed cellulose, also the MFA can be measured (Jang, H. F. (1998), Journal of Pulp and Paper Science, 24, 224-230). This method needs not only pretreatment of fibers (dyed with special fluorochromes) but also rotation of the incident polarized light.

Imaging ellipsometry enables nondestructive determination of both the MFA and the path difference PD or phase retardation Δ, a parameter proportional to the CWT, without sample pretreatment (Ye, C. and Sundström, M. O. PCT Patent Application (1996), WO9610168). The path difference PD or phase retardation Δ is proportional to the cell wall thickness d as described by PD=Δλ/2π=d(n₂−n₁) or Δ=2πd(n₂−n₁)/λ, where n₂−n₁ is the birefringence of the wall material and λ the light wavelength. In most applications, it is important to know the distribution of fibers' wall thicknesses instead of their absolute values. In these cases, the absolute quantity is not necessary and a parameter like the path difference PD, which is proportional to the CWT, can directly be used for replacing the CWT, as experimentally demonstrated (Ye C, Räty, J., Nyblom, I., Hyvärinen, H. and Moss, P. (2001), Nordic Pulp & Paper Research Journal. 2(16), 143-148). Furthermore, the CWT can be determined from the PD with a proper calibration procedure.

In an early work of imaging ellipsometry, a theoretical model describing the two-wall structure of a pulp fiber was established and a multiple-wavelength method was developed based thereon for measuring both the retardation Δ and the MFA of single pulp fibers (Ye, C, Sundström, M. O., and Remes, K. (1994), Appl. Opt. 33, 6626-6637 and Ye, C. and Sundström, M. O. PCT Patent Application (1996), WO9610168). According to the new model, the two opposite cell walls (S₂ layer) of a fiber is optically equivalent to two identical linear retarders arranged in series with their axes symmetrical around the fiber axis. The two retarders have the same phase retardation Δ, which is proportional to the thickness of the fiber walls and the birefringence of the wall material, and their orientation angles have the same value as the microfibril angle φ of the fiber, but with opposite signs.

The multiple-wavelength method enabled non-destructive measurement of wood or pulp fibers for the MFA φ and phase retardation Δ without sample pretreatment. The method employs a plane polariscope and it measures light intensities of a fiber sample at different wavelengths (at least two) by rotating the analyzer of the plane polariscope. With the intensity data obtained, intermediate results for φ and [symbol] at each wavelength are calculated, from which the measurement results of φ and [symbol] at each wavelength are determined according to the criteria that the MFA φ is a constant parameter, whereas the phase retardation Δ is a function of the light wavelength λ as described by Δ=2πd(n₂−n₁)/λ, where d is the thickness of fiber's cell walls and n₂−n₁ is the birefringence of the wall material. Then an optimal estimation for φ and Δ is obtained by comparing the measured results as a function of the light wavelength with the theoretical description according to the least squares principle. However, the fiber sample has to be aligned to a certain orientation. Due to this limitation, the measurement speed is restricted to be further increased.

Later a more advanced method (Ye, C. (1999) Appl. Opt. 38, 1975-1985) was developed based on the Mueller-matrix ellipsometry. The Mueller-matrix method permits non-destructive determination of the MFA and Δ of a wood or pulp fiber oriented arbitrarily by measuring the Mueller matrix of the fiber at one wavelength. This method has all the advantages of the multiple-wavelength method but not subject to the same limitation. Based on this method, a more powerful research tool (Ye C, Räty, J., Nyblom, I., Hyvärinen, H. and Moss, P. (2001), Nordic Pulp & Paper Research Journal. 2(16), 143-148) for characterization of pulp fivers was constructed, which allows a semi-automatic measurement of single wood or pulp fibers for the MFA and Δ with the measurement speed significantly enhanced. However, the Mueller-matrix method still needs the fiber sample keeping stationary during measurement and requires sequentially acquiring images from the fiber sample.

Most recently, another ellipsometric method (Jang, H. F. (2005), US Patent Application, US 2005/9122514 A1) is reported for measurement of the microfibril angle MFA and the phase retardation Δ. The method of Jang employs a circular polariscope (Theocaria, P. S. and Gdoutos, E. E., Matrix Theory of Photoelasticity, Springer-Verlag, New York, 1979, pages 117-123), which creates an image determined only by the sample's properties related to polarized light. With a circular polariscope it is not necessary to align the sample because the equipment is insensitive to the sample's orientation. This method is also a multiple-wavelength method and it measures light intensities of a fiber sample created with the circular polariscope at several well-separated wavelengths (at least three). The microfibril angle MFA and phase retardation Δ are determined from the measured intensity data by fitting the data with the theoretical description.

Theoretically it is feasible to automate the method of Jang for real-time or on-line measurement of wood or pulp fiber properties with the circular polariscope adapted to be able to simultaneously create and detect multiple images of the sample at individual wavelengths. As known, the light intensity emergent from a fiber, no matter in a plane or circular polariscope, is non-linearly related to the fiber's properties, the incident light and the light wavelength. The non-linear relationship between the intensity data and the unknowns to be determined implies that light intensity measurement at two wavelengths is not enough to determine two unknown parameters of the sample, e.g. the microfibril angle and phase retardation, in all cases, in which fibers have different cell wall thicknesses ranging to cover all possible values for the phase retardation Δ. In fact, a simulation calculation shows that ambiguous results can occur when determining φ and Δ even in case of measuring light intensities at three wavelengths. This is a liability for the method of Jang. To guarantee the measurement results reliable, the number of individual wavelengths, at which light intensity needs to measure, should be higher or much higher than stated by Jang. For a non real-time measurement, this is not a big problem. However, it will be completely different if multiple images need to be simultaneously created and detected to realize real-time measurement especially when the number of the wavelengths increases. In addition, the light intensity incident on the fiber sample is an additional unknown parameter, which needs to be determined to measure the microfibril angle and phase retardation. A practical system meeting the requirements above is not only complicated and expensive but also technically not desired because for example the light intensity of the multiple images will be further reduced with increasing number of wavelengths.

For pulp fiber characterization, valuable fiber quality information needs to be gathered from a representative sample of thousands of individual fibers so that a real-time measurement method is the most desirable, capable of measuring a great mass of fibers in sufficiently short time to provide more reliable results and statistical analysis. Furthermore, because of largely automated pulping process it is more important that a real-time measurement method can be used or adapted for use under the on-line condition to measure moving fibers to provide on-line feedback information of the fiber quality for pulp evaluation and controlling the production process. As described above, however, the methods so far available for determination of the MFA φ and the CWT or PD are either limited for use in laboratories or restricted for the liabilities.

### SUMMARY OF THE INVENTION

It is therefore an object of the present invention to provide a method and equipment capable of real-time measurement of wood or pulp fibers for both the microfibril angle and the path difference without sample pretreatment.

It is another object of the invention to provide a better solution for the real-time measurement of wood or pulp fibers, which enables measurement of a fiber or a moving fiber oriented arbitrarily for the microfibril angle and phase retardation by acquiring only one image from the fiber and capable of generating the reliable measurement results by over-determining the parameters to avoid possible ambiguous data in signal processing.

The present invention provides a method developed based on the spectroscopic ellipsometry as a solution for this challenging task. The method of the invention employs a circular polariscope in combination with a line spectral camera with the former generating a polarizing micrograph of a pulp fiber under test, which is insensitive to the fiber's orientation, and the latter completing a real-time spectral analysis of the micrograph generated.

A circular polariscope (Theocaria, P. S. and Gdoutos, E. E., Matrix Theory of Photoelasticity, Springer-Verlag, New York, 1979, pages 117-123) has an optical arrangement comprising two achromatic quarter-wave retarders inserted between and oriented perpendicular or parallel to each other and at 45° to a pair of parallel or perpendicular polarizers with the fibers for measurement, preferably immersed and distributed in suspension, embraced by the retarders. The image of a wood or pulp fiber created by the arrangement is independent of the fiber's orientation and it is formed or determined only by the fiber's MFA φ and phase retardation Δ in addition to the incident light intensity. With this property, the equipment of the invention enables measurement of a fiber oriented arbitrarily.

Another aspect of the method of the invention is to simultaneously measure all the light intensities emergent from a fiber sample in a continuous spectral range, from which a real-time spectral analysis of the fiber image can be carried out and the unknown parameters φ and Δ can be over-determined to avoid any possible ambiguous results and to improve the measurement accuracy. For this purpose, the method of the invention uses a line spectral camera placed behind the circular polariscope. The light emergent from the exit polarizer of the polariscope is scanned by a line spectral camera, which preferably is an ImSpector (http://www.specim.fi/) followed by a CCD camera. The ImSpector captures a line image of the fiber's image and disperses light from the line image into a continuous spectrum, which is detected by the CCD camera, so that a real-time spectroscopic analysis is feasible. As the MFA φ is a constant parameter, while the retardation α is a function of the light wavelength λ, as described by Δ=2πd(n₂−n₁)/λ, where d is the thickness of fiber's cell walls and n₂−n₁ is the birefringence of the wall material, a spectroscopic analysis of the invention based on the least-squares principle results in an optimal estimation for φ and Δ.

A further aspect of the invention is to determine the incident light intensity without using additional component. This is desired or needed to carry out a spectral analysis of the sample image as mentioned above so that the unknown parameters φ and Δ can be determined by acquiring and using only one image created from the circular polariscope. Because the incident light intensity of a fiber sample in a practical system is also a function of the light wavelength λ, it is necessary to compensate the effect caused by the spectral transmission of the incident light intensity to measure the fiber's φ and Δ. In accordance with the invention, when a fiber is measured an image part is captured by the spectral camera, which contains the fiber's segment selected for measurement and a neighboring background image part without fiber. The CCD camera behind the ImSpector detects and outputs the spectrum I[Δ(λ),φ] of the selected fiber segment and the spectrum I₀(λ) of the background image part as well. The background image part is near the fiber segment to measure and it can be used to approximately describe the light intensity transmitted by the equipment and detected by the CCD camera at the position of the fiber segment in case the fiber is absent. The spectrum I[Δ(λ),φ] is normalized with I₀(λ) and the normalized spectrum I[Δ(λ),φ]/I₀(λ), which is independent of the spectral transmission of the equipment or the incident light intensity, is used for the real-time spectroscopic analysis, from which an optimal estimation for the fiber's φ and Δ can be generated based on the least square principle.

As only one image from the fiber sample is needed, the method of the present invention exerts no restriction on the measurement speed and does not need special equipment having complicated structure for simultaneously creating and detecting multiple images from the sample. In addition, as experimentally demonstrated this exclusive feature of the invention allows measurement of a moving fiber oriented arbitrarily for φ and Δ, an assignment required for fiber measurement under the on-line condition.

The equipment of the invention is developed based on the invention and it works as a spectroscopic imaging ellipsometer without moving part capable of measuring wood or pulp fibers oriented arbitrarily by acquiring only one image from the fibers. Besides the wood pulp fiber, the method is suitable for measurement of other cellulose fibers. In addition, the method and equipment of the invention can be used or adapted for use for real-time or on-line measurement of ordinary birefringent samples including retardation films and waveplates. The principle, advantages and features of this invention will become more apparent from the following description in conjunction with the accompanying drawings.

### BRIEF DESCRIPTION OF THE DRAWINGS

FIG. 1 is a schematic diagram of the equipment of the present invention for real-time or on-line measurement of the microfibril angle and the phase retardation of intact wood or pulp fibers.

FIG. 2 is a schematic diagram of the equipment of the present invention modified for real-time or on-line measurement of an ordinary birefringent sample, typically a retardation film or waveplate.

FIG. 3, comprising FIGS. 3a-3b, are the real image (FIG. 3a) of a fiber segment (pine kraft pulp) measured by the equipment of the present invention and the spectral image (FIG. 3b) dispersed from the fiber segment, I: selected fiber segment for measurement, I₀: selected background image of the empty equipment, I[Δ(λ),φ], I₀(λ): spectral distributions dispersed from the segments I and I₀.

FIG. 4 shows the measured spectral transmission function T[Δ(λ),φ] of the fiber in FIG. 3a and its fitting curve in the range of 400-710 nm generated when Δ=102.4° (550 nm) and φ=8.9°.

FIG. 5, comprising FIGS. 5a-5b, are the measured phase retardation Δ (FIG. 5a) and microfibril angle (FIG. 5b) of the fiber segment shown in FIG. 3a as a function of the fiber's orientation angle θ.

FIG. 6, comprising FIGS. 6a-6b, are the real image (FIG. 6a) of a fiber segment (birch kraft pulp) measured by the equipment of the present invention and the spectral image (FIG. 6b) dispersed from the fiber segment, I: selected fiber segment for measurement, I₀: selected background image of the equipment, I[Δ(λ),φ], I₀(λ): spectral distributions dispersed from the segments I and I₀.

FIG. 7, comprising FIGS. 7a-7b, are the measured phase retardation Δ (FIG. 7a) and microfibril angle (FIG. 7b) of the fiber segment shown in FIG. 6a as a function of the fiber's orientation angle θ.

### DESCRIPTION OF THE PREFERRED EMBODIMENT

A wood or pulp fiber under investigation in the present invention is assumed to be a flattened cylinder in shape and its two walls are of the same thickness and their microfibrils lay symmetrically around the fiber axis. It is also assumed that a narrow region in the middle of the cell walls is examined so that the effect caused by light scattering at the fiber wall edges can be ignored. Under these conditions, the structure of a pulp fiber can be described according to the two-wall model (Ye, C. and Sundström, M. O. PCT Patent Application (1996), WO9610168 and Ye, C, Sundström, M. O., and Remes, K. (1994), Appl. Opt. 33, 6626-6637) with its opposite cell walls approximated by two identical linear retarders in series with their axes symmetrical around the fiber axis. The two retarders have the same relative retardation Δ, which is proportional to the thickness of the fiber walls and the birefringence of the wall material, and their orientation angles have the same value as the microfibril angle φ of the fiber, but with opposite signs. The properties of a wood or pulp fiber related to the polarized light can be described by using the Mueller-matrix formulation (e.g. refer Theocaris, P. S. and Gdoutos, E. E. (1979), Matrix Theory of Photoelasticity, Springer-Verlag Berlin, and Kliger, D. S., Lewis, J. W. and Randall, C. E. (1990), Polarized light in optics and spectroscopy, Academic Press, Harcourt Brace Jovanovich). As calculated (Ye, C, Räty, J., Nyblom, I., Hyvärinen, H. and Moss, P. (2001), Nordic Pulp and Paper Research Journal. 16, 143-148), the Mueller matrix T of a wood or pulp fiber having the retardation Δ and microfibril angle φ when it is in an optical system with the fiber's axis oriented at an angle θ related to a chosen reference axis can be expressed by

$$\begin{matrix}T = [ \begin{matrix}1 & 0 & 0 & 0 \\ 0 & {t}_{22} & {t}_{23} & {t}_{24} \\ 0 & {t}_{32} & {t}_{33} & {t}_{34} \\ 0 & {t}_{42} & {t}_{43} & {t}_{44}\end{matrix} ] , & ( 1 ) \\ where & \\ {t}_{22} = {m}_{22} {cos}^{2} 2 θ + {m}_{33} {sin}^{2} 2 θ , \\ {t}_{23} = {m}_{23} + ( {m}_{22} - {m}_{33} ) sin 2 θ cos 2 θ , \\ {t}_{24} = {m}_{24} cos 2 θ - {m}_{34} sin 2 θ , \\ {t}_{32} = {m}_{32} + ( {m}_{22} - {m}_{33} ) sin 2 θ cos 2 θ , \\ {t}_{33} = {m}_{22} {sin}^{2} 2 θ + {m}_{33} {cos}^{2} 2 θ , \\ {t}_{34} = {m}_{24} sin 2 θ + {m}_{34} cos 2 θ , \\ {t}_{42} = {m}_{42} cos 2 θ - {m}_{43} sin 2 θ , \\ {t}_{43} = {m}_{42} sin 2 θ + {m}_{43} cos 2 θ , \\ {t}_{44} = 1 - 2 {cos}^{2} 2 {ϕsin}^{2} Δ & ( 2 a \text{-} i ) \\ with & \\ \begin{matrix}{m}_{22} = 1 - 2 {sin}^{2} 4 ϕ {sin}^{4} \frac{Δ}{2} , & \end{matrix} \\ {m}_{23} = - {m}_{32} = 2 sin 4 ϕ {sin}^{2} \frac{Δ}{2} ( 2 {cos}^{2} 2 ϕ {sin}^{2} \frac{Δ}{2} - 1 ) , \\ {m}_{24} = {m}_{42} = - 4 sin 2 ϕ {cos}^{2} 2 ϕ {sin}^{2} \frac{Δ}{2} sin Δ , \\ {m}_{33} = 1 + 8 {sin}^{2} \frac{Δ}{2} {cos}^{2} 2 ϕ ( {sin}^{2} \frac{Δ}{2} {cos}^{2} 2 ϕ - 1 ) , \\ {m}_{34} = - {m}_{43} = 2 cos 2 ϕ sin Δ ( 1 - 2 {cos}^{2} 2 ϕ {sin}^{2} \frac{Δ}{2} ) . & ( 3 a \text{-} e )\end{matrix}$$

According to Equations (1-3), the matrix element t₄₄=1−2cos²2φsin²Δ is a function of the retardation Δ and MFA φ, but independent of the fiber's orientation angle θ. The method of the present invention uses a circular polariscope (Theocaria, P. S. and Gdoutos, E. E., Matrix Theory of Photoelasticity, Springer-Verlag, New York, 1979, pages 117-123) that allows transmission of the matrix element t₄₄ through and filters out the all other matrix elements so that it is insensitive to the orientation of a fiber and thus can be used for its real-time measurement. The equipment of the present invention uses the optical arrangement of a circular polariscope to acquire the required measurement information from the fiber sample in combination with a proper spectral analysis.

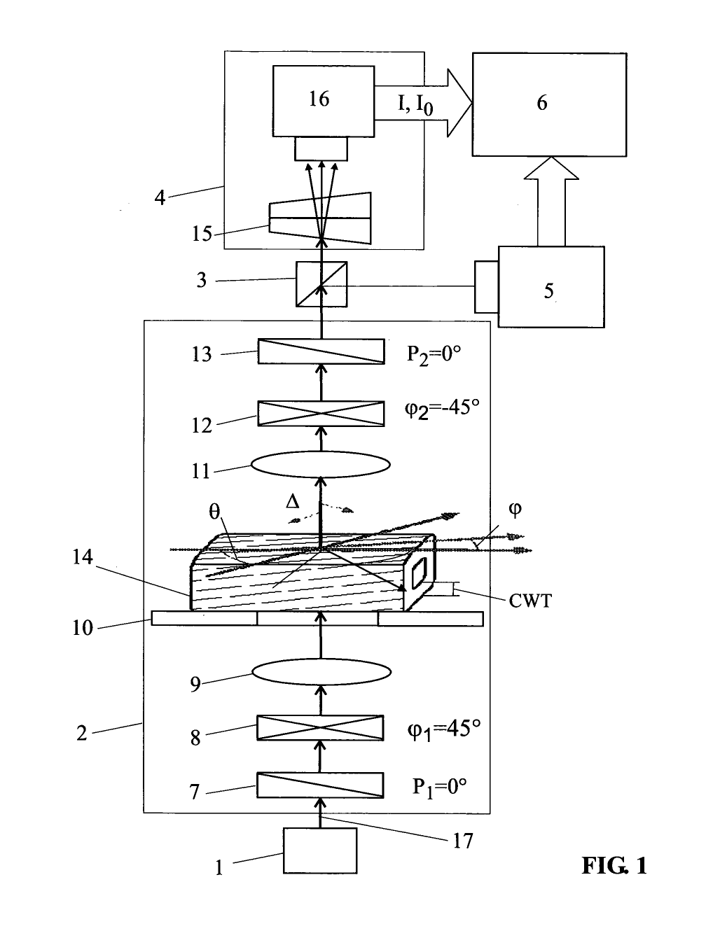

FIG. 1 schematically illustrates the equipment of the present invention for determining the microfibril angle and the phase retardation of intact pulp fibers. The equipment comprises a light source 1, a polarization-optical imaging system 2, a beamsplitter 3, a line spectral camera 4 and a CCD camera 5 in connection to an image-processing unit 6. The imaging system 2 has an optical arrangement same as that of a circular polariscope, consisting of an entrance polarizer 7 (azimuth P₁=0°), a first quarter-wave retarder 8 (orientation angle φ₁), a microscope condenser 9, a sample unit 10, a microscope objective 11, a second quarter-wave retarder 12 (orientation angle φ₂) and an exit polarizer 13 (azimuth P₂). The light source 1 generates a light beam 17 having a broad spectrum in a predetermined wavelength range, preferably in the visible or ultraviolet-visible range. The light beam 17 enters the polarization-optical imaging system 2 and it is linearly polarized by the polarizer 7. The linearly polarized light goes through the quarter-wave retarder 8 and it is focused to a wood or pulp fiber 14 (microfibril angle φ, retardation Δ=Δ(λ) and fiber orientation angle θ) under test in the sample unit 10 through condenser 9. The light emergent from the fiber 14 is imaged by the objective 11 and it passes through the quarter-wave retarder 12 and the polarizer 13. The polarizer 13 is aligned to be parallel (as in FIG. 1) or perpendicular to the polarizer 7, i.e. P₂=0° or P₂=90°. The quarter-wave retarders 8 and 12 are achromatic in the wavelength range of the equipment with their retardation errors negligible. They are oriented at 45° related to the entrance polarizer 7. They may be either perpendicular (as in FIG. 1) or parallel to each other, i.e. φ₁=45° and φ₂=−45° or φ₁=45° and φ₂=45° for P₂=0° or P₂=90°. With the fiber's Mueller matrix T described by Equations (1-3), the intensity I=I[Δ(λ),φ] of the emergent light from the polarizer 13 as a function of the light wavelength in the spectral range of the equipment for P₂=0° or P₂=90° when the retarders 8 and 12 are perpendicular (φ₁=45° and φ₂=−45°) or parallel (φ₁=45° and φ₂=45°) to each other can be calculated as given by

$$I = \frac{{I}_{0}}{2} ( 1 + {t}_{44} ) = {I}_{0} [ 1 - {cos}^{2} 2 {ϕsin}^{2} Δ ( λ ) ] \qquad ( 4 )$$

where I₀ is the light intensity transmitted by the equipment and detected by the spectral camera 4 when the fiber 14 is absent in sample unit 10. In principle, the condenser 9 can be placed at any position between the light source 1 and the fiber 14 while the objective 11 may be anywhere between the fiber 14 and the beamsplitter 3.

According to the invention, an optimal estimation of φ and Δ can be generated with a proper spectroscopic analysis of the light intensity I=I[Δ(λ),φ], because the MFA φ is a constant parameter, while the retardation Δ is a function of the light wavelength λ as described by Δ=2πd(n₂−n₁)/λ. The light beam emergent from the polarizer 13 is divided into two component beams by the beamsplitter 3. One of the split beams reaches CCD camera 5 and the other one is scanned by the spectral camera 4. Only for the purpose of measuring a fiber's φ and Δ, it is not necessary to split the light beam into two component beams. The image of the fiber 14 generated by CCD camera 5 is desirable to serve for controlling and monitoring the measurement procedure and it is interfaced or outputted to image-processing unit 6 and can additionally be used for determining the other parameters of the fiber such as the length, width and shape. The spectral camera 4 typically is a line spectral camera, consisting of an ImSpector 15 followed by a CCD camera 16. The ImSpector 15 is a grating-based imaging spectrograph device and it captures a line image of the fiber's polarizing micrograph and disperses light from the line image into spectrums, which are detected by the CCD camera 16, so that a real-time spectroscopic analysis is feasible.

For a practical system, not only the incident light intensity but also the transmission of each optical component and the response of a used detector as well is a function of the light wavelength X. This means that the light intensity I₀ transmitted by the empty equipment is also a function of the light wavelength, i.e. I₀=I₀(λ), which is contributed by the spectral transmission of all the components in the equipment and the spectral response of the detector to be used in addition to the incident light. Thus, it is necessary to compensate the effect caused by the light intensity I₀(λ) in order to determine the parameters φ and Δ based on Equation (4). In accordance with the invention, when a fiber segment is measured, a neighboring background image part without fiber is selected and also scanned by the ImSpector 15. The CCD camera 16 detects and outputs both the spectrum I=I[Δ(λ),φ] of the selected fiber segment and the spectrum I₀=I₀(λ) of the background image part, which is of the same size as that of the selected fiber segment. Because the background image part I₀(λ) is near the fiber segment to be measured and it can be used to approximately describe the light intensity transmitted by the equipment and detected by the CCD camera 16 at the position of the fiber segment in case the fiber is absent. The spectrums I[Δ(λ),φ] and I₀(λ) are sent to the image-processing unit 6, which is interfaced to a computer, where the spectrums I[Δ(λ),φ] and I₀(λ) are digitized. With the help of proper software, the obtained data are further processed in the computer and the spectrum I[Δ(λ),φ] of the fiber 14 is normalized with I₀(λ). The normalized spectrum T=I[Δ(λ),φ]/I₀(λ) is determined only by the parameters φ and Δ and from Equation (4) it can be calculated as given by

T=1−cos² 2φ sin² Δ(λ) (5)

The spectral analysis of the present invention is based on Equation (5) and the least-squares principle. A fitting curve is calculated according to Equation (5) and compared with the measured spectrum T. Estimates may be given for the parameters φ and Δ of the fitting curve as their starting values. Then the measurement results or the optimal estimation for φ and Δ can be generated by varying the estimates for φ and Δ in accordance with the least-squares principle until the sum of the squares of the measured spectral transmission T with respect to the fitting curve is minimized.

The solution provided by the present invention for real-time measurement of intact wood or pulp fibers for the microfibril angle φ and the phase retardation Δ mainly has two exclusive features. As described above, the spectrum T=I[Δ(λ),φ]/I₀(λ) of a fiber segment is created and measured in a continuous spectral range, containing the data at all wavelengths in the equipment's spectral range, so that the parameters φ and Δ are over-determined. In this way, any ambiguous measurement results possibly occurred when determining φ and Δ due to insufficient spectral data can be avoided and the measurement accuracy can additionally be improved. Another feature of the invention is that it needs acquiring only one image from the sample and thus it dispenses with special equipment for simultaneously creating and detecting multiple images, which are expensive and technically not desirable.

The equipment of the invention works as a spectroscopic imaging ellipsometer without moving part and it measures a pulp fiber oriented arbitrarily by acquiring only one image from the fiber. Due to this feature, the equipment can be employed for measuring moving fibers if a high-speed CCD camera is used. In addition, it is feasible to measure several fibers simultaneously. It is obvious that the method and equipment of the invention can further be used or adapted to be used for measurement of pulp fibers under on-line conditions. For this purpose, the sample unit 10 of the equipment can be a capillary (e.g. Kajaani FS-200) or a flowing cuvette. The fibers to be measured will be guided for sequentially passing through the capillary or flowing cuvette for measurement.

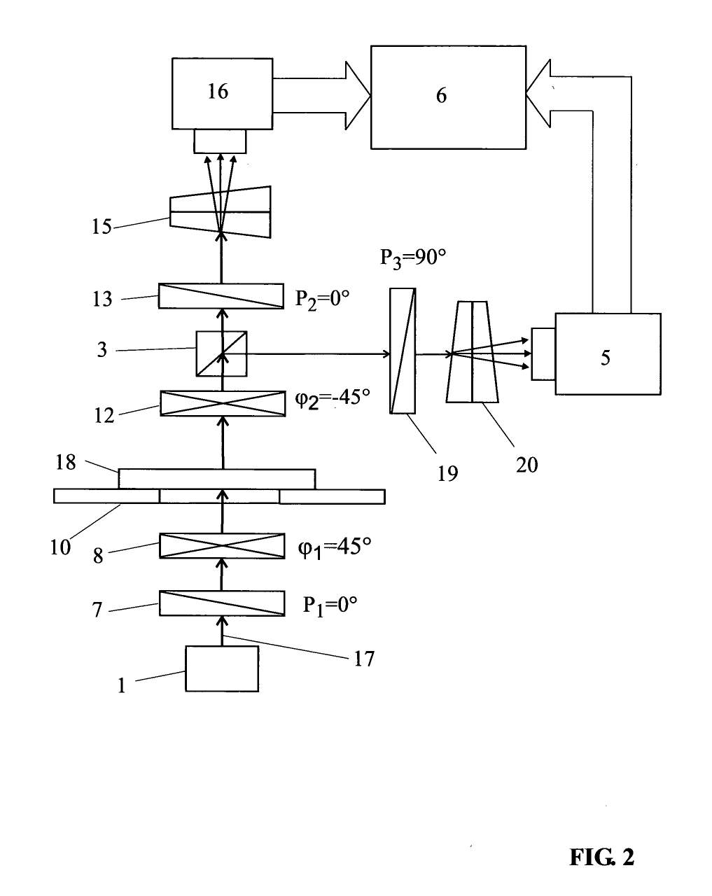

The equipment of the invention can be modified for real-time or on-line measurement of other birefringent samples such as retardation films and waveplates in addition to other birefringent particles. Because a retardation film or waveplate is not a micro sample as wood fibers, the condenser 9 and the objective 11 are not necessary and thus can be removed. However due to this reason, the method described above for determining the light intensity I₀(λ) or I₀ cannot directly be applied. A retardation film or waveplate can be considered as a special fiber sample with an imaginary microfibril angle φ=0° and the retardation of its cell walls equal to half the retardation of the retardation film or waveplate. FIG. 2 shows the modified equipment of the invention for measurement of an ordinary birefringent sample 18, typically a retardation film or waveplate. In the modified equipment, the beamsplitter 3 is located immediately behind the second quarter-wave retarder 12, which splits the beam into two component beams with one of the component beam, after passing through the exit polarizer 13 (azimuth P₂) and ImSpector 15, detected by the CCD camera 16, which outputs the spectrum I[Δ(λ)] of the sample 18 as described by Equation (4) for φ=0. The modified equipment further comprises a second exit polarizer 19 and a second ImSpector 20, arranged together with CCD camera 5 such that the other component beam is detected by CCD camera 5 after going through the exit polarizer 19 and the ImSpector 20. The ImSpector 15 and ImSpector 20 are adjusted so that they scan the same segment of the birefringent sample 18. The exit polarizer 19 (azimuth P₃) is oriented perpendicular to the exit polarizer 13, i.e. P₃=90° and P₂=0° for φ₁=45° and φ₂=−45° or P₃=0° and P₂=90° for φ₁=45° and φ₂=45°, so that the CCD camera 5 detects a spectrum I_{c}=I_{c}[Δ(λ)] as given by

I_{c}=I₀ sin² Δ(λ), (6)

which is complementary to I[Δ(λ)] such that I[Δ(λ)]+I_{c}[Δ(λ)]=I₀(λ). The spectrums I[Δ(λ)] and I₀(λ) are sent to the image-processing unit 6, where the spectrum I[Δ(λ)] of the sample 18 is normalized with I₀(λ) and the normalized spectrum T=I[Δ(λ)]/(I[Δ(λ)]+I_{c}[Δ(λ)]) is used for determining the retardation of sample 18 according to the method of least-squares principle described above.

To test the present invention, a polarizing microscope (Leica DM RX HC, Leica Microsystems Wetzlar GmbH, Wetzlar Germany) was reconstructed with additional optical components added in accordance with the arrangement in FIG. 1. The polarizers of the reconstructed microscope were oriented parallel to each other. Two achromatic quarter-wave retarders (WPAC4, Karl Lambrecht Corporation, Chicago USA) were inserted respectively above and under the microscope's workstage and oriented with their axes perpendicular to each other and at 45° related to the polarizers. Pulp fibers for measurement were immersed and distributed in a mixture of water (50%) and glycerin (50%) between a microscope slide and cover glass and the slide was placed on the microscope's workstage so that the fibers were between the quarter-wave retarders. In addition, a double video adapter was used, positioned on the microscope's tube, in which the light emergent from the microscope was split into two beams. The two exits of the double video adapter were interfaced to a CCD camera and a line spectral camera, which was an ImSpector (V8E, Specim Ltd, Oulu, Finland) followed by another CCD camera.

Experiments and measurements were carried out, in which single pulp fibers were measured by using the constructed equipment. To better test the method and the equipment's real-time measurement capability, a fiber for measurement was repeatedly measured after it was rotated to different orientations. A fiber for measurement was first oriented with the fiber's axis parallel or approximately parallel to the polarizers' axes (θ=0°), i.e. the reference axis, and it was then rotated to new orientations from θ=0° to θ=180° with an increment of 22.5°. The present invention will be explained in more detail with reference to the following Examples, which are a small part of the results obtained in the measurements.

### EXAMPLE 1

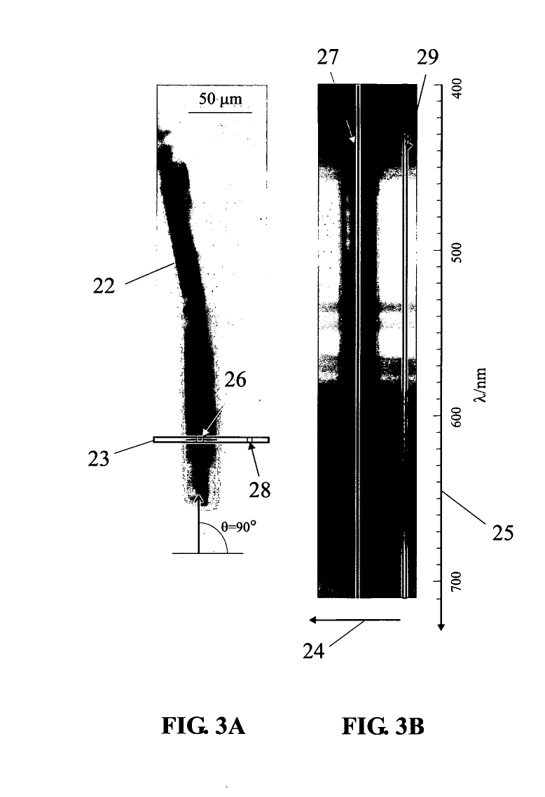

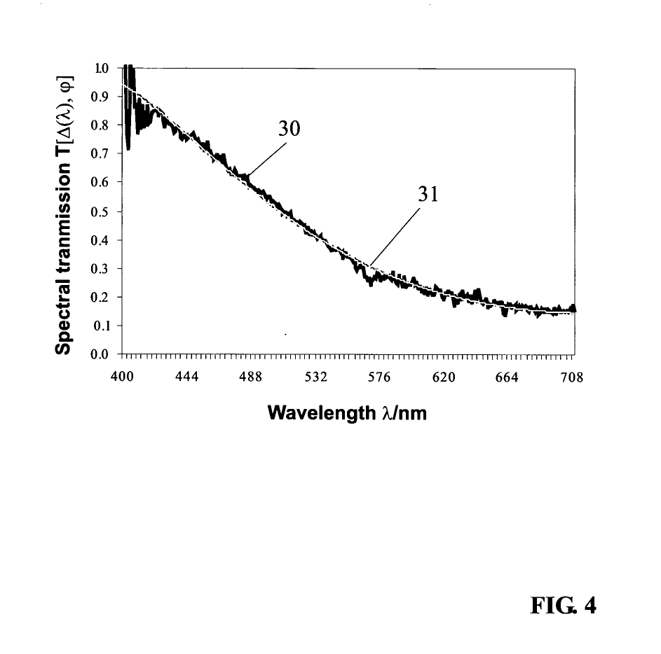

The first example is a measured pine kraft pulp fiber. As an example, FIG. 3a shows the image of this fiber 22 at θ=90°, with a narrow rectangle window 23 added, which schematically illustrates the position of the ImSpector's scanning slit at the sample's plane. The image part inside the window 23 was scanned by the ImSpector and dispersed into spectral intensity distribution (spectral image) as shown by FIG. 3b. The spectral image contains the line pixels in spatial axis 24 and spectral pixels in spectral axis 25. The value of wavelength λ of the spectral axis 25 is ascending in the marked direction. A small area 26 at the central region of the scanned fiber segment in the window 23 was selected for measurement and the light intensity of the area 26 is I. The dispersed spectral image from the segment 26 of intensity I is a narrow rectangle fringe 27 in FIG. 2b showing the intensity spectral distribution of I, i.e. I[Δ(λ),φ]. A small rectangle area 28 of the background image near the fiber segment 26, which is of the same width as that of the segment 26, was selected as reference marked with the light intensity I₀. The reference image area 28 of intensity I₀ was dispersed into a narrow rectangle fringe 29 in FIG. 3b, which describes the spectral distribution of I₀, i.e. I₀(λ). From the spectrums I[Δ(λ),φ] and I₀(λ), the spectral transmission function T[Δ(λ),φ]=I[Δ(λ),φ]/I₀(λ) of the measured fiber segment 26 was determined. FIG. 4 shows the obtained curve 30 for T[Δ(λ),φ] and its fit curve 31 in the range of 400-710 nm calculated according to the least-squares principle and Equation (5), which was generated with Δ=120.1° (550 nm) and φ=11.1°.

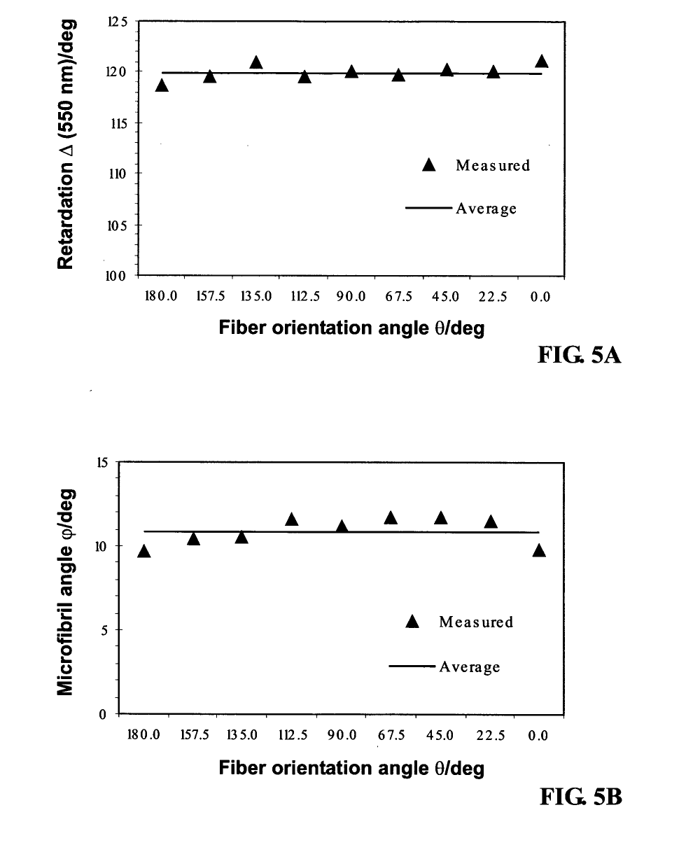

The fiber of FIG. 3a was rotated to different orientations and it was repeatedly measured when it was at a new orientation. FIG. 5 shows the measurement results of the fiber segment 26 in FIG. 3a for Δ (FIG. 5a) and φ (FIG. 5b) obtained when it was at different orientation angles θ. The results for Δ and φ obtained at different fiber orientations coincide well with one another. As calculated, the relative retardation errors are smaller than about 1.1% and the maximum deviation of the data of φ is smaller than 1.20° if the average of the all obtained data of Δ or φ is taken as the final result.

### EXAMPLE 2

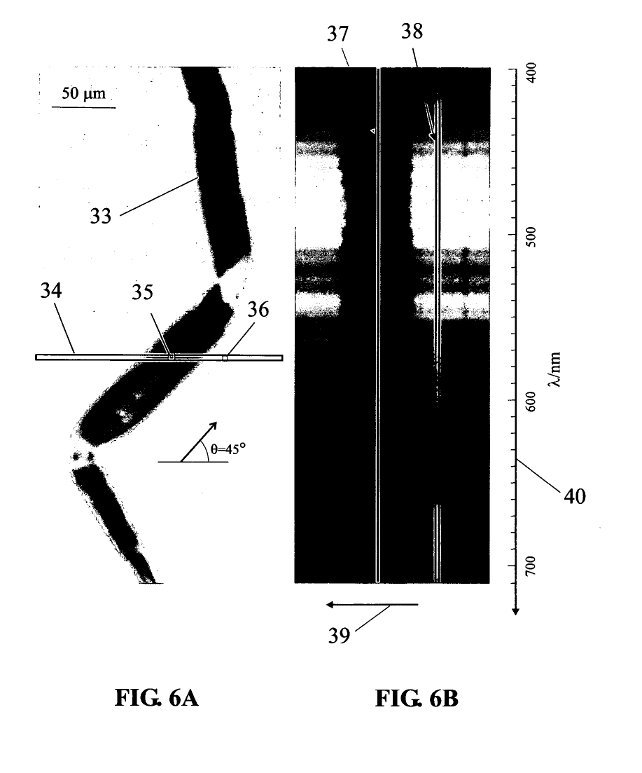

The second example was a birch kraft pulp fiber. As an example, FIG. 6 shows the real image (FIG. 6a) of this fiber 33 at θ=45° with an added window 34 illustrating the position of the ImSpector's scanning slit at the sample's plane. A segment 35 of intensity I of the fiber 33 was selected for measurement and its dispersed spectral image is the narrow fringe 37 in FIG. 6b, i.e. I[Δ(λ),φ]. A small area 36 of the background image near the fiber segment 35 in FIG. 6a was used as reference with the light intensity I₀. The reference image 36 of I₀ was dispersed into a narrow rectangle fringe 38 in FIG. 6b, which describes the spectral distribution of I₀(λ). In the spectral image of FIG. 6b, the line pixels are presented in spatial axis 39 and the wavelength λ values are specified in spectral axis 40.

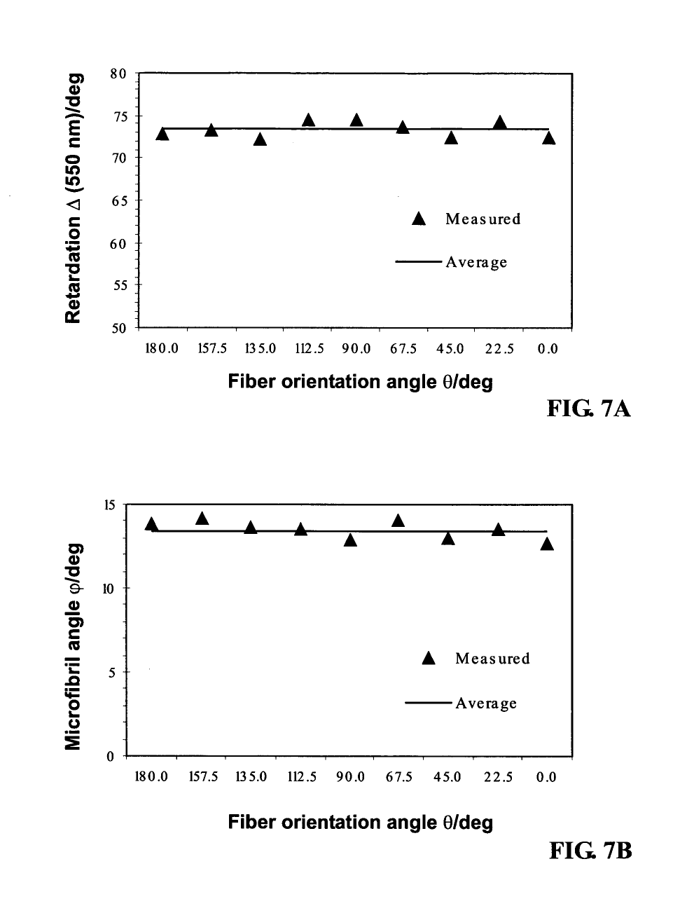

The measurement results of the fiber segment 35 in FIG. 6a for Δ and φ as a function of the fiber's orientation angle θ are presented in FIG. 7a and FIG. 7b, respectively.

1. Equipment for measurement of a sample by obtaining only one image from the sample, the equipment comprising:
a light source for generating a light beam having a broad spectrum in a predetermined wavelength range,
a circular polariscope, which comprises an entrance polarizer, in operative engagement with the light source,
a first quarter-wave retarder in operative engagement with the entrance polarizer,
a second quarter-wave retarder in operative engagement with the first quarter-wave retarder,
an exit polarizer in operative engagement with the second quarter-wave retarder,
a CCD camera in operative engagement with the exit polarizer, and
means for image and data processing comprising a sample unit and an imaging spectrograph device, the means for image and data processing being in operative engagement with the CCD camera.

2. The equipment of claim 1 wherein the sample is placed in or on the sample unit.

3. The equipment of claim 1 wherein the light source, the entrance polarizer, the first quarter-wave retarder, the sample unit with the sample disposed therein, the second quarter-wave retarder, the exit polarizer, the imaging spectrograph device and the CCD camera are arranged in series along the light beam generated from the light source with the entrance and exit polarizers oriented parallel or perpendicular to each other and the first and second quarter-wave retarders having their axes oriented perpendicular or parallel to each other and at 45° relative to the entrance polarizer.

4. The equipment of claim 1 wherein the sample is a wood or pulp fiber, and the equipment further comprises a condenser or a condenser together with an objective for measurement of the wood or pulp fiber for a microfibril angle φ and a phase retardation Δ.

5. The equipment of claim 4 wherein the condenser and objective are inserted into the light beam, located between the light source and the sample unit and between the sample unit and the imaging spectrograph device, respectively.

6. The equipment of claim 4 wherein an image of the wood or pulp fiber formed behind the exit polarizer is insensitive to an orientation of the wood or pulp fiber and is determined only by the microfibril angle φ and the phase retardation Δ of the wood or pulp fiber with Δ=2πd (n2−n1)/λ, where (d) is a thickness of cell walls of the wood or pulp fiber, (n2−n1) is an birefringence of a wall material and (λ) is a light wavelength.

7. The equipment of claim 1 wherein the CCD camera constitutes a spectral camera and the CCD camera is interfaced with the means for image and data processing.

8. The equipment of claim 1 wherein the imaging spectrograph device is adapted to capture a line image across the wood or pulp fiber.

9. (canceled)

10. The equipment of claim 1 wherein the equipment further comprises a beam-splitter and a second CCD camera with the beam-splitter being inserted immediately before the imaging spectrograph device.

11. The equipment of claim 1 wherein the equipment is a microscope, and the sample unit is a microscope sample slide equipped with an specimen guide or a flowing cuvette.

12. The equipment of claim 1 wherein the sample is a birefringent sample characterized by a phase retardation Δ and the equipment further comprises a beam-splitter, a second exit polarizer, a second imaging spectrograph device and a second CCD camera interfaced with the means for image and data processing and further wherein the beam-splitter is located immediately behind the second quarter-wave retarder.

13. The equipment of claim 12 the exit polarizer is identical to the second exit polarizer, the imaging spectrograph device is identical to the second imaging spectrograph device, and the CCD camera is identical to the second CCD camera, the second exit polarizer is oriented perpendicular to the exit polarizer so that a sum of spectrums generated by the imaging spectrograph device and the second imaging spectrograph device is equal to a spectrum generated by the imaging spectrograph device when the birefringent sample is absent in the sample unit.

14. (canceled)

15. A method for measurement of a sample by obtaining only one image from the sample, comprising:
providing a light source generating light beam having a broad spectrum in a predetermined wavelength range, an entrance polarizer, a first quarter-wave retarder, a sample unit, a second quarter-wave retarder, an exit polarizer, an imaging spectrograph device, a CCD camera and means for image and data processing,
placing the sample in the sample unit to have an image of the sample generated behind the exit polarizer,
guiding or locating the sample with the sample unit such that the imaging spectrograph device captures a line image across the sample and a neighboring background image part that does not contain any sample and dispersing light from the line image into spectrums in the wavelength range,
detecting the spectrums with the CCD camera,
digitizing and processing obtained data of the spectrums with the means for image and data processing,
normalizing the spectrum generated from the sample with that of the background image part in the means for image and data processing,
calculating a theoretical curve with first estimation values given for parameters of the sample to be determined in the theoretical curve in the wavelength range,
comparing the theoretical curve with a normalized spectrum by varying the first estimation values of the parameters until a sum of squares of the normalized spectrum with respect to the theoretical curve over the wavelength range is minimized, and
taking the first estimation values of the parameters generated when the sum is minimized as measurement results of the sample.

16. The method of claim 15 wherein the sample is a wood or pulp fiber characterized by a microfibril angle φ and a phase retardation Δ.

17. The method of claim 15 wherein the theoretical curve is calculated according to a spectrum description l−cos²2 φsin²Δ and the microfibril angle φ and the phase retardation Δ are determined with all data of the normalized spectrum.

18. The method of claim 16 wherein the image of the wood or pulp fiber formed behind the exit polarizer is insensitive to an orientation of the wood or pulp fiber in the sample unit and is determined only by the microfibril angle and phase retardation of the wood or pulp fiber, the CCD camera is interfaced with the means for image and data processing wherein intensity data detected by the CCD camera are digitized and processed.

19. The method of claim 16 further comprising the steps of providing a beam-splitter and a second CCD camera with the beam-splitter being inserted immediately before the imaging spectrograph device to split the beam emergent from said exit polarizer into two component beams with, a component beams detected by the CCD camera after passing through the imaging spectrograph device and the second CCD camera interfaced to the means for image and data processing and located to detect another component beams and the second CCD camera detects and outputs an image of the fiber, which serves for controlling and monitoring the measurement procedure of φ and Δ and additionally for determining other parameters of the wood of pulp fiber including a length, width and shape.

20. The method of claim 15 further comprising:
providing a light source, an entrance polarizer, a first quarter-wave retarder, a sample unit, a second quarter-wave retarder, an exit polarizer, a second exit polarizer, an imaging spectrograph device, a second imaging spectrograph device, a CCD camera, a second CCD camera and means for image and data processing,
placing a birefringent sample on the sample unit to have an image of the birefringent sample generated behind the exit polarizer,
locating the imaging spectrograph device and the second imaging spectrograph device to capture a same line image of the sample and disperse light from the line image into spectrums,
detecting the spectrums with the CCD camera and the second CCD camera,
digitizing and processing obtained data of the spectrums with the means for image and data processing,
normalizing the spectrum detected by the CCD camera with a sum of the spectrums detected by the CCD camera and the second CCD camera in the means for image and data processing,
calculating a theoretical curve according to a spectrum description COS²Δ/2 with a first estimation value given for Δ in the theoretical curve,
comparing the theoretical curve with a normalized spectrum by varying the first estimation value of Δ until a sum of squares of the normalized spectrum with respect to the theoretical curve over the wavelength range is minimized, and
taking the first estimation value of Δ generated when a least-squares sum is minimized as a measurement result of the birefringent sample.

21. The method of claim 15 wherein the light source generates a light beam having a broad spectrum over a wavelength range, the method further comprises replacing the light source by an assembly comprising laser diodes at wavelengths, the first and second quarter-wave retarders are identical and achromatic over a wavelength range and the sample unit is a microscope sample slide equipped with specimen guide or a capillary or flowing cuvette that holds the suspension and guides fibers in a suspension sequentially passing through, or a device that guides and moves an ordinary birefringent sample for measurement on the equipment.

22. The method of claim 20 is characterized in that the image of the birefringent sample formed behind the exit polarizer is insensitive to an orientation of the birefringent sample on the sample unit and is determined only by the phase retardation of the birefringent sample, the CCD camera or second CCD camera constitute a spectral camera, the CCD camera and second CCD camera are interfaced with the means for image and data processing, where intensity data detected by the CCD camera and second CCD camera are digitized and processed.
